(19) United States
(12) Patent Application Publication
(10) Pub. No.: US 2015/0349690 A1
(43) Pub. Date: Dec. 3, 2015

(54) Driving Signal Generator and Method of Generating Driving Signal

(71) Applicant: RICHTEK TECHNOLOGY CORP, Hsinchu (TW)

(72) Inventors: Wei-Hsu Chang, Hsinchu (TW); Jo-Yu Wang, Hsinchu (TW)

(21) Appl. No.: 14/335,877

(22) Filed: Jul. 19, 2014

(30) Foreign Application Priority Data
May 27, 2014 (TW) 103118352

(51) Int. Cl. H02P 23/04; H02P 25/06; H02P 25/16

(52) U.S. Cl. CPC H02P 23/04; H02P 25/16; H02P 25/06

(57) ABSTRACT

A driving signal generator for driving a transducer includes: an input terminal for receiving a control signal; and a digital filter, coupled to the input terminal, for generating a driving signal to drive the transducer in response to the control signal. The digital filter is a notch filter, and the transfer function of the digital filter is related to the characteristics of the transducer.

### CROSS-REFERENCE TO RELATED APPLICATIONS

This non-provisional application claims priority claim under 35 U.S.C. §119(a) on Taiwan Patent Application No. 103118352 filed May 27, 2014, the entire contents of which are hereby incorporated by reference.

### BACKGROUND

2. Technical Field

The present disclosure relates to a driving signal generator and a method of generating a driving signal and, more particularly, to a driving signal generator applied to a transducer having a peaking on the magnitude of frequency-domain response and a method of generating a driving signal.

2. Description of Related Art

A transducer is a component that converts a signal in one form of energy to another form of energy. Transducers are widely used, in many portable electronics, as a display panel, a loudspeaker, and a voice coil motor, which is required for auto-focus in a camera lens, to name a few. These three different types of transducers respectively receive a control signal in a form of electric energy and convert the signal into a form of optical, acoustic, and mechanical energy, in order to meet various sensory requirements.

For various controls of transducers, if the output signal of a transducer is monotonically increasing or decreasing with respect to the input signal of the transducer, the control of the transducer can be based on an open-loop configuration which, for example, is used in the design of a display panel. To achieve better control of the transducer, the control can be based on a close-loop circuit, which is more complex than the open-loop counterpart. However, a close-loop control circuit requires additional hardware cost in order to acquire the signals fed back from the transducer. FIG. 1 shows a frequency-domain response plot of the transfer function according to the magnitude of a conventional voice coil motor. As the frequency increases, there exists a peaking on the magnitude before the high frequency starts to attenuate, and the peaking is subject to form a resonant frequency such that when receiving an impulse or step energy, the voice coil motor will vibrate for a specified time period at such frequency. For example, when the voice coil motor is applied to the auto-focus system of the camera lens, the vibration of the voice coil motor will, if sustained for a long time, adversely increase the system response time, making this camera product less competitive in the market. The peaking problem can be solved by adopting a close-loop control circuit. By adjusting the parameters in the negative feedback system, such that the response of the voice coil motor control system is equipped with adequate damping factor to avoid vibration. In the circuit of the negative feedback system, a Hall sensor is incorporated to detect the displacement of the voice coil motor and to feed the electrical signals being converted back to the control system. The close-loop based control system is an effective solution at the expense of hardware cost and circuit area, and therefore may not be justified in a modern design.

Alternatively, the peaking problem can be solved by adopting an open-loop control circuit. A notch filter is incorporated in the control system such that the peaking on the magnitude of frequency-domain response of the voice coil motor can be filtered, and thus the vibration is suppressed. Compared with the close-loop configuration, the open-loop configuration reduces more hardware costs and circuit areas. However, in practice, the frequency at the peaking tends to drift due to temperature change, component aging, or differences between components, and should be taken into account in the open-loop based control system.

FIG. 2 shows a circuit block diagram of a conventional voice coil motor control system 200 with open-loop control configuration. The control system 200 includes a notch filter 210 having a magnitude of frequency response F(z), where the notch frequency fn is designed to be close to the peaking frequency fr of the voice coil motor 220. The control system 200, after incorporating the voice coil motor 220, generates a time-domain output response x(t) to avoid the vibration when the input signal u(t) is either an impulse or a step signal.

FIG. 3 shows a time-domain waveform diagram of a voice coil motor implemented by the conventional control system shown in FIG. 2, where the notch filter 210 is implemented by a digital filter with the following frequency response F(z):

F(z)=0.5·(1+z⁻¹) (1)

where z is a variable of the Z-transform, and z⁻¹ refers to the delay for the width of the operating clock of the digital filter; that is, F(z) is a Z-domain function. Moreover, the term of F(z) with highest degree is z⁻¹, meaning that F(z) is a first-order function. It should be noted that, in practice, the notch frequency fn of the notch filter 210 should be close to the peaking frequency fr, and, by incorporating Eq. (1), the width of the operating clock of the digital filter can be determined. In FIG. 3, the driving signal u′(t), generated by the notch filter 210, is a step signal, as shown in the top figure, and the time-domain output response x(t), in response to the driving signal u′(t), is shown in the bottom figure. It is shown that the vibration has been suppressed completely and the response time is half of the resonant cycle Tc (i.e., the reciprocal of the resonant frequency).

### SUMMARY

In view of the foregoing, the present disclosure provides a driving signal generator and a method of generating a driving signal, in which the driving signal generator is applied to a transducer having a peaking on the magnitude of frequency-domain response.

To this end, this disclosure provides a driving signal generator for driving a transducer. The driving signal generator includes: an input terminal for receiving a control signal; and a digital filter coupled to the input terminal and generating a driving signal to drive the transducer in response to the control signal. The digital filter of the driving signal generator is a notch filter and the transfer function of the digital filter is related to the characteristics of the transducer.

In one embodiment, the driving signal generator does not contain a loop fed back from the transducer.

In one embodiment, the driving signal generator is based on an open-loop control configuration.

This disclosure further provides a method of generating a driving signal. The method includes the following steps: receive a control signal via the input terminal of a digital filter and generate a driving signal by the digital filter, where the digital filter is a notch filter with a transfer function relating to the characteristics of a transducer; and drive the transducer with the driving signal by the digital filter.

In one embodiment, the transducer has a peaking on the magnitude of frequency-domain response.

In one embodiment, the transducer is an inductive component.

In one embodiment, the transfer function of the digital filter is denoted by:

(1+a₁·z⁻ⁿ+a₂·z⁻²ⁿ)·F1,

where F1 is an at least first-order Z-domain function, a₁ is a real number less than 0, a₂ is a real number greater than 0, and n is a natural number.

In one embodiment, the transfer function of the digital filter may be as follows:

(1+a₁·z⁻ⁿ+a₂·z⁻²ⁿ)·F1

In one embodiment, the transfer function of the digital filter may be as follows:

0.5·(1−z⁻²+z⁻⁴)·(1+z⁻⁷)

The driving signal generator and the method of generating a driving signal of the present disclosure effectively, under an open-loop control configuration, minimize, or suppress, the unnecessary vibration of the transducer, which is caused by the peaking, thereby substantially improving response time. This disclosure has the advantages of faster response time and wider notch range over the prior art, and thus achieves more practical applicability.

### BRIEF DESCRIPTION OF THE DRAWINGS

The structure as well as a preferred mode of use, further objects, and advantages of this disclosure will be best understood by referring to the following detailed description of some illustrative embodiments in conjunction with the accompanying drawings, in which:

FIG. 1 is a frequency-domain response plot of the transfer function according to the magnitude of a voice coil motor in the art;

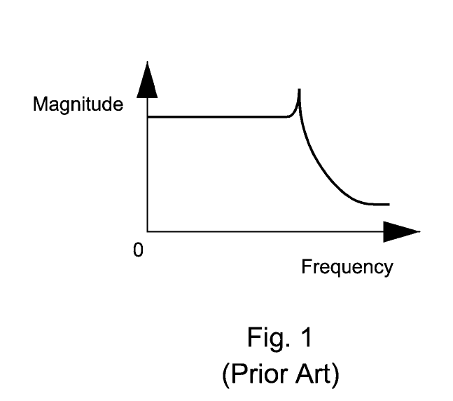

FIG. 2 is a circuit block diagram showing a voice coil motor control system with open-loop control configuration in the art;

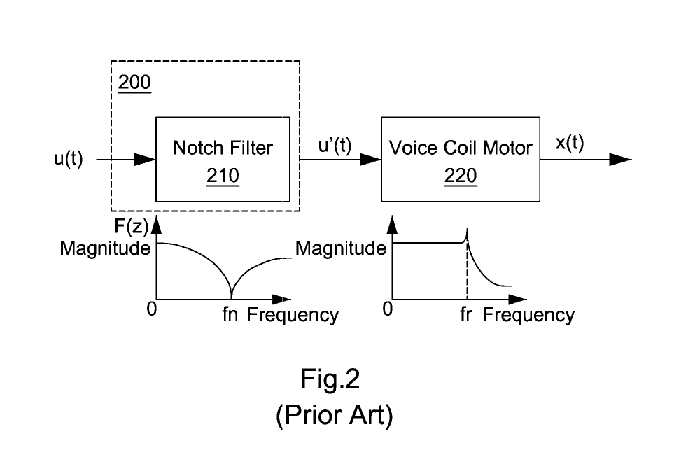

FIG. 3 is a time-domain waveform diagram of a voice coil motor implemented by the control system shown in FIG. 2;

FIG. 4 is a circuit block diagram incorporated with a driving signal generator according to an embodiment of this disclosure;

FIG. 5 is a time-domain waveform diagram of a driving signal generator according to an exemplary embodiment of this disclosure;

FIG. 6 is time-domain waveform diagram of a driving signal generator according to a preferred embodiment of this disclosure; and

FIG. 7 is a flowchart of a method of generating a driving signal according to an embodiment of this disclosure.

### DETAILED DESCRIPTION OF THE PREFERRED EMBODIMENTS

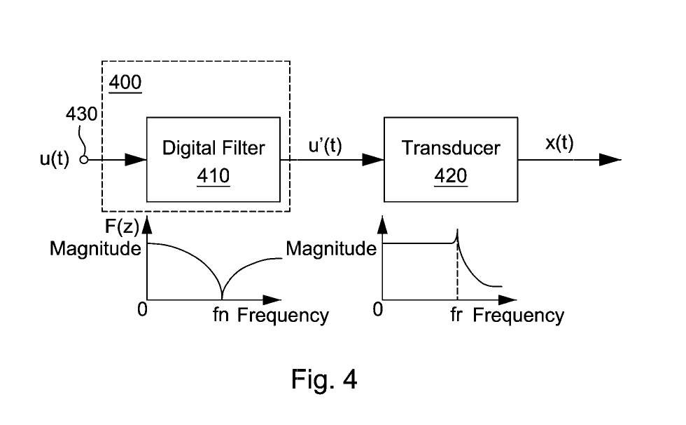

Referring to FIG. 4, the driving signal generator 400, according to an embodiment of the present disclosure, is configured to receive a control signal u(t) for driving a transducer 420. The driving signal generator 400 includes an input terminal 430 and a digital filter 410. The input terminal 430 is used to receive the control signal u(t). The digital filter 410 is coupled to the input terminal 430 and generates a driving signal u′(t) to drive the transducer 420 in response to the control signal u(t), where the digital filter 410 is a notch filter, and the transfer function of the digital filter 410 is related to the characteristics of the transducer 420.

It is noted that the driving signal generator 400 of this disclosure does not contain the loop fed back from the transducer 420, so, in the circuit, the component used for energy conversion to generate feedback signals is not needed, and therefore the hardware cost is reduced. As in the case that the transducer is a voice coil motor, a component like, for example, a Hall sensor, is provided in the circuit, to detect the displacement of the voice coil motor so as to acquire the feedback signals, where the feedback signals are converted into electrical signals to be fed back to the control system for further processing. Moreover, the driving signal generator 400 is based on an open-loop control configuration, so a faster system response time is achieved. While in a close-loop control configuration setting, the system response is, inevitably, compromised for loop stability.

Furthermore, the transducer 420 applied in the driving signal generator 400 of this disclosure has a peaking on the magnitude of frequency-domain response. The peaking, in essence, tends to cause a vibration on the displacement in the transducer 420. The driving signal generator 400 is configured to suppress the vibration. The transducer 420 is preferably an inductive component which is, for example, a voice coil motor.

In one embodiment, the transfer function F(z) of the digital filter 410 is denoted by:

F(z)=(1+a₁·z⁻ⁿ+a₂·z⁻²ⁿ)·F1 (2)

where F1 is an at least first-order Z-domain function, a₁ is a real number less than zero, a₂ is a real number greater than zero, and n is a natural number.

By applying different F1 functions and different values of a₁, a₂, and n, the driving signal generator 400 of the present disclosure not only compensates for possible drift due to the peaking frequency by acquiring wider notch range, but also has a faster response time over the prior art. The preferred embodiments of this disclosure are detailed as follows.

In one embodiment of the driving signal generator 400, a1 is −1, a2 is 1, and n is 1,meaning that the transfer function F(z)of the digital filter 410 has the following factor:

1−z⁻¹+z⁻² (3)

That is, F(z) is the function as follows:

(1−z⁻¹+z⁻²)·F1 (4)

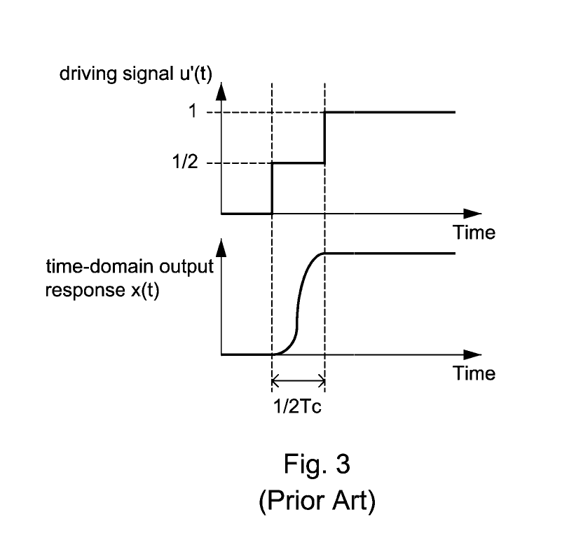

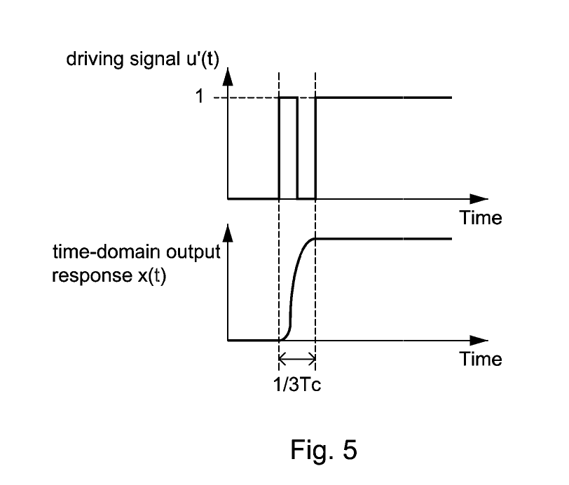

The term of Eq. (3) with highest degree is Z⁻², so Eq. (3) is a second-order function. FIG. 5 shows the time-domain waveform diagram of the driving signal generator 400 implemented by Eq. (3). It should be noted that, in practice, the notch frequency fn of the digital filter 410 should be close to the peaking frequency fr, and, by incorporating Eq. (3), the width of the operating clock frequency of the digital filter can be determined. In FIG. 5, the driving signal u′(t), generated by the digital filter 410, is a step signal, as shown in the top figure, and the time-domain output response x(t), in response to the driving signal u′(t), is shown in the bottom figure. It is shown that the vibration has been suppressed and the response time of the driving signal generator 400 is only one third of the resonant cycle Tc, which is faster as compared with that of the prior art, with the response time being half of the Tc (as in FIG. 3).

In another embodiment of the driving signal generator 400, a₁ is −1, a₂ is 1, n is 2,and F1=1+z⁻⁷, where F1 is a seventh-order function. That is, the transfer function F(z) of the digital filter 410 is denoted by:

F(z)=0.5·(1−z⁻²+z⁻⁴)·(1+z⁻⁷) (5)

The transfer function F(z) as in Eq. (5) has a wider notch range, and therefore is used to compensate for possible drift due to the peaking frequency, where the drift may be caused by temperature change, component aging, and/or the differences between components.

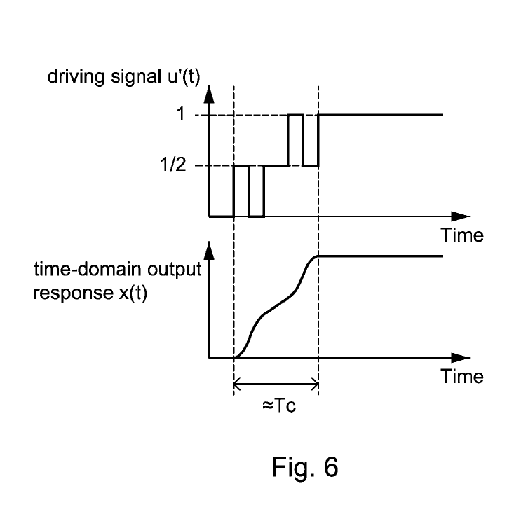

FIG. 6 shows the time-domain waveform diagram of the driving signal generator 400 implemented by Eq. (5). It should be noted that, in practice, the notch frequency fn of the digital filter 410 should be close to the peaking frequency fr, and, by incorporating Eq. (5), the width of the operating clock frequency of the digital filter 410 can be determined. In FIG. 6, the driving signal u′(t), generated by the digital filter 410, is a step signal, as shown in the top figure, and the time-domain output response x(t), in response to the driving signal u′(t), is shown in the bottom figure. It is shown that the vibration has been suppressed. The response time of the driving signal generator 400 is close to the resonant cycle Tc; however, the driving signal generator 400 has a wider notch range, and thus is less susceptible to the drift of the peaking frequency. Therefore, compared with the prior art, the present embodiment of the driving signal generator 400, configured to process under a wider notch range, has a faster response time.

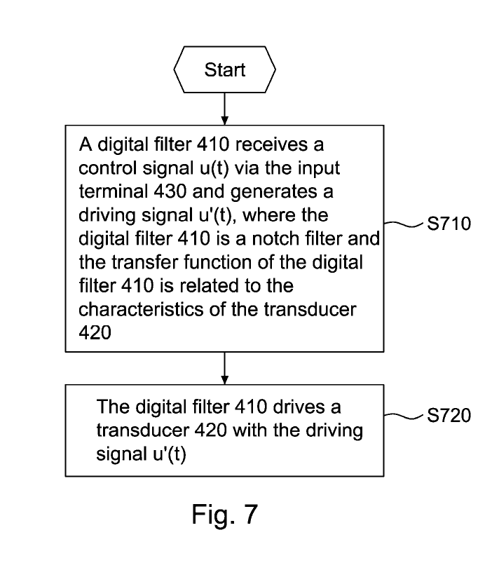

FIG. 7 shows the flowchart of the method of generating a driving signal according to an embodiment of this disclosure. The driving signal is used to drive a transducer 420 having a peaking on the magnitude of frequency-domain response. The transducer 420 is preferably an inductive component which is, for example, a voice coil motor. The method of generating a driving signal includes the following steps.

In step 1, as indicated in S710, a digital filter 410 receives a control signal u(t) via the input terminal 430 and generates a driving signal u′(t), where the digital filter 410 is a notch filter and the transfer function of the digital filter 410 is related to the characteristics of the transducer 420. Compared with the prior art, the digital filter 410 has a faster response time and a wider notch range so as to compensate for possible drift due to the peaking frequency.

In step 2, as indicated in S720, the digital filter 410 drives a transducer 420 with the driving signal u′(t).

The method of generating a driving signal of this present disclosure effectively, under an open-loop control, minimizes, or suppresses, the vibration of a transducer, which is caused by the peaking, thereby substantially improving response time. In sum, this disclosure has the advantages of faster response and wider notch range over the prior art, and thus achieves more practical applicability.

In one preferred embodiment, the transfer function F(z) of the digital filter is denoted by:

F(z)=(1+a₁·z⁻ⁿ+a₂·z⁻²ⁿ)·F1 (6),

where F1 is an at least first-order Z-domain function, a1 is a real number less than zero, a2 is a real number greater than zero, and n is a natural number.

By applying different F1 functions and different values of a₁, a₂, and n, the method of generating a driving signal of the present disclosure not only compensates for possible drift due to the peaking frequency by acquiring wider notch range, but also has a faster response time over the prior art.

In one preferred embodiment, the transfer function F(z) of the digital filter is denoted by:

F(z)=(1−z⁻¹+z⁻²)·F1 (7)

Compared with the prior art (as in FIG. 3), the digital filter represented by Eq. (7) has a faster response time with a wider notch range.

In one preferred embodiment, the transfer function F(z) of the digital filter is denoted by:

F(z)=0.5·(1−z⁻²+z⁻⁴)·(1+z⁻⁷) (8)

Compared with the prior art, the transfer function of the digital filter has a wider notch range so as to compensate for possible drift due to the peaking frequency, where the drift may be caused by temperature change, component aging, and/or essential differences among components.

What is claimed is:

1. A driving signal generator for driving a transducer, comprising:
an input terminal, for receiving a control signal; and
a digital filter, coupled to said input terminal and for generating a driving signal to drive said transducer based on said control signal;
wherein said digital filter is a notch filter, and the transfer function of said digital filter is related to the characteristics of said transducer.

2. The driving signal generator as of claim 1, wherein said driving signal generator does not contain a loop fed back from said transducer.

3. The driving signal generator as of claim 1, wherein said driving signal generator is based on an open-loop control configuration.

4. The driving signal generator as of claim 1, wherein a peaking exists on the magnitude of frequency-domain response of said transducer.

5. The driving signal generator as of claim 1, wherein said transducer is an inductive component.

6. The driving signal generator as of claim 1, wherein the transfer function of said digital filter is denoted by:
(1+a₁·z⁻ⁿ+a₂·z⁻²ⁿ)·F1,
where F1 is an at least first-order Z-domain function, a1 is a real number less than zero, a2 is a real number greater than zero, and n is a natural number.

7. The driving signal generator as of claim 1, wherein the transfer function of said digital filter is denoted by:
(1−z⁻¹+z⁻²)·F1,
where F1 is an at least first-order Z-domain function.

8. The driving signal generator as of claim 1, wherein the transfer function of said digital filter is denoted by:
0.5·(1−z⁻²+z⁻⁴)·(1+z⁻⁷).

9. A method of generating a driving signal, applied in a driving signal generator configured to drive a transducer, said method comprising the steps of:
receiving a control signal via the input terminal of a digital filter and generating a driving signal by said digital filter, where said digital filter is a notch filter with a transfer function relating to the characteristics of said transducer; and
driving said transducer with said driving signal by said digital filter.

10. The method as of claim 9, wherein a peaking exists on the magnitude of frequency-domain response of said transducer.

11. The method as of claim 9, wherein said transducer is an inductive component.

12. The method as of claim 9, wherein the transfer function of said digital filter is denoted by:
(1+a₁·z⁻ⁿ+a₂·z⁻²ⁿ)·F1,
where F1 is an at least first-order Z-domain function, a1 is a real number less than zero, a2 is a real number greater than zero, and n is a natural number.

13. The method as of claim 9, wherein the transfer function of said digital filter is denoted by:
(1−z⁻¹+z⁻²)·F1,
where F1 is an at least first-order Z-domain function.

14. The method as of claim 9, wherein the transfer function of said digital filter is denoted by:
0.5·(1−z⁻²+z⁻⁴)·(1+z⁻⁷).
